(19) United States
(12) Patent Application Publication
(10) Pub. No.: US 2005/0174325 A1
(43) Pub. Date: Aug. 11, 2005

(54) Electronic device with finger sensor for character entry and associated methods

(75) Inventor: Dale R. Setlak, Melbourne, FL (US)

Correspondence Address: CHRISTOPHER F. REGAN;Allen Dyer Milbrath and Gilchrist PA, 255 S Orange Ave, Orlando, FL, 32801, US

(73) Assignee: Authen Tec, Inc., Melbourne, FL (US)

(21) Appl. No.: 11/021,896

(22) Filed: Dec. 23, 2004

Related U.S. Application Data
(60) Provisional application No. 60/532,136, filed on Dec. 23, 2003.

(51) Int. Cl. G09G 5/00

(52) U.S. Cl. 345/156

(57) ABSTRACT

An electronic device includes a housing and a finger sensor carried by the housing to receive a fingerprint area of a user's finger adjacent thereto. A processor can be carried by the housing and connected to the finger sensor. The processor determines a plurality of finger motion patterns of the fingerprint area of the user's finger relative to the finger sensor. The processor also matches the determined finger motion patterns to stored finger motion patterns of respective characters, and may display the characters as text on a display. The finger sensor may also be used to verify the user based upon a fingerprint, for example.

### RELATED APPLICATION

This application is based upon prior filed copending provisional application Ser. No. 60/532,136 filed Dec. 23, 2003, the entire subject matter of which is incorporated herein by reference in its entirety.

### FIELD OF THE INVENTION

The invention relates to the field of electronic devices, and, more particularly, to electronic devices and methods permitting user input of characters.

### BACKGROUND OF THE INVENTION

A laptop or desktop computer typically includes a full size alphanumeric keyboard to permit a user to enter data, text, etc. into the computer. This data or text may then be processed, printed, and/or stored.

A Personal Digital Assistant (PDA), for example, is a small handheld device typically used for organizational tasks, such as scheduling and note taking. Because the PDA is too small to carry a conventional full-size keyboard, a sensing surface and hand-manipulated stylus permit user input of alphanumeric characters using a so-called Graffiti language. Predetermined stroke patterns of the stylus on the sensing surface correspond to respective alphanumeric characters. A display typically also reveals the alphanumeric characters deciphered based upon the stroke patterns.

Some of these devices may also restrict access to confidential data by requiring a biometric input. For instance, U.S. Pat. No. 6,595,342 to Maritzen et al. discloses a portable electronic device that includes a touch screen responsive to a user manipulated stylus to input data using the Graffiti language. The Maritzen et al. patent also discloses a separate fingerprint sensor on the portable electronic device that can be used for user authentication. Similarly, U.S. Pat. No. 6,751,734 to Uchida discloses a portable electronic device in which characters can be entered with a stylus, and that includes a separate fingerprint sensor to authenticate a user. U.S. Pat. No. 6,711,460 to Reese discloses a customer terminal that includes a touch screen or Graffiti pad by which a user can enter characters into the customer terminal, and a separate fingerprint sensor.

U.S. Pat. No. 6,732,278 to Baird, III et al. discloses a portable electronic device that includes a Graffiti interface and a handwriting biometric system. The Baird, III et al. patent discloses that the portable electronic device can authenticate a user based on handwriting on the Graffiti interface.

Unfortunately, the stylus can become lost or separated from the PDA. In the case where the stylus is specially configured for the PDA, the user would be unable to enter data into the PDA using the Graffiti language. In the case where the stylus is not specially configured for the PDA, it is known that a user can enter data into the PDA using a fingernail edge as a substitute stylus. Manipulating one's fingernail edge along predefined patterns may be awkward and may lead to inaccuracies.

A cellular telephone is desirably so compact that room is not typically available for a writing surface using a stylus. Indeed, many cellphones are so compact that a single input key or switch is used to enter a selected one from among a number of different characters. For example, the number of times a key is depressed may set the desired character, such as where three alphanumeric characters are available from a given input key.

### SUMMARY OF THE INVENTION

In view of the foregoing background, it is therefore an object of the invention to provide an electronic device and associated method that permits efficient and accurate user entry of characters such as without need for a stylus.

This and other objects, features, and advantages in accordance with the invention are provided by an electronic device that includes a finger sensor for character entry. More particularly, the device may include a housing and a display carried by the housing. The finger sensor may be carried by the housing to receive a fingerprint area of a user's finger adjacent thereto. A processor may be carried by the housing, and may be connected to the finger sensor and the display. The processor may determine a plurality of finger motion patterns of the fingerprint area of the user's finger relative to the finger sensor and match the determined finger motion patterns to stored finger motion patterns for respective characters. The processor may also generate text on the display based upon the characters. Accordingly, the electronic device permits user entry of characters in an efficient and accurate manner without requiring a stylus.

The finger sensor may further comprise a fingerprint image sensor for generating fingerprint image data, and the processor may generate and compare successive slices of fingerprint image data to determine the finger motion patterns. For example, the fingerprint image sensor may comprise a substrate and an array of fingerprint sensing pixels on the substrate, such as electric field sensing pixels.

The processor may further comprise a deciphering module for performing the determining and matching of the finger motion patterns. Moreover, the processor may also further comprise a verification module for determining an authorized user based upon a fingerprint image. In these advantageous embodiments, the finger sensor may be used for both verification and character entry.

The characters generated by the electronic device may comprise alphabet characters, numeric characters, and/or control characters, for example. The finger motion pattern may comprise a finger vertical motion, finger horizontal motion, and/or finger rotational motion. The finger motion pattern may further comprise a finger lifting motion representing transition to a next character, for example.

In some embodiments, the electronic device may further comprise a wireless transceiver carried by the housing and connected to the processor. The wireless transceiver may provide a wireless link to a wireless communications network, such as a cellular telephone network, wireless LAN, or other similar network. The processor may also comprise a scheduling module for organizing a user's schedule data, for example.

The housing may comprise a portable housing to be carried by the user. In other words, the electronic device may be a cellular phone or PDA, for example.

A method aspect of the invention is for using an electronic device that includes a display, and a finger sensor to receive a fingerprint area of a user's finger adjacent thereto. The method may include determining a plurality of finger motion patterns of the fingerprint area of the user's finger relative to the finger sensor, and matching the determined finger motion patterns to stored finger motion patterns for respective characters. The method may further include generating text on the display based upon the characters.

### BRIEF DESCRIPTION OF THE DRAWINGS

FIG. 1 is a schematic diagram of a first embodiment of an electronic device in accordance with the invention.

FIGS. 2-4 are successive schematic fingerprint image slices as may be used by the device of FIG. 1.

FIG. 5 is a more detailed schematic diagram, partially in section, of a portion of the electronic device as shown in FIG. 1.

FIG. 6 is a schematic diagram of a second embodiment of an electronic device in accordance with the invention.

FIG. 7 is a more detailed schematic diagram, partially in section, of a portion of the electronic device as shown in FIG. 6.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

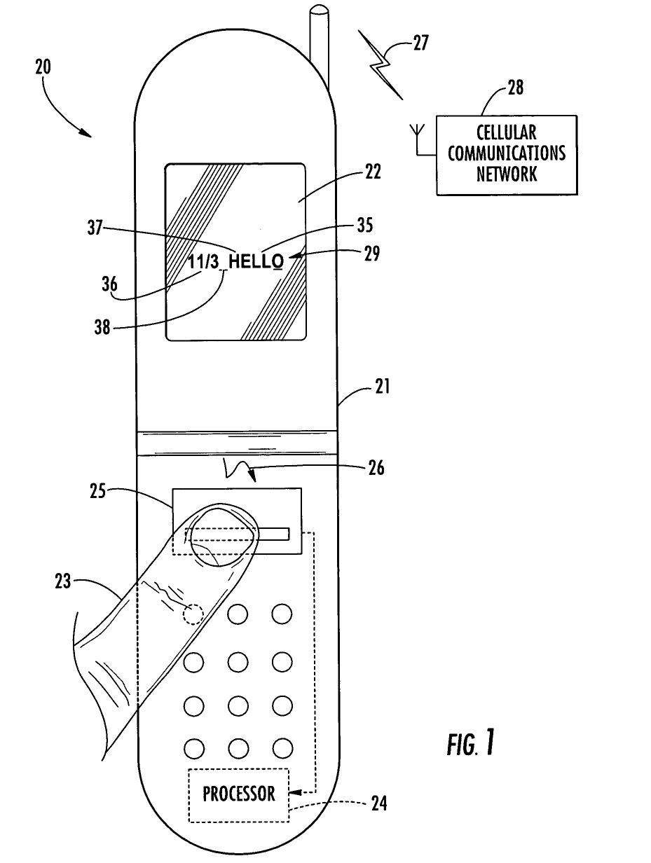

Referring initially to FIGS. 1-4, an electronic device 20 in accordance with the invention is now described. The electronic device 20 includes a relatively small and compact housing 21, such as to be carried in a user's hand. A finger sensor 25 is carried by the housing 21 to receive a fingerprint area of a user's finger 23 adjacent thereto.

A processor 24 is carried by the housing 21 and connected to the finger sensor 25. The processor 24 determines a plurality of finger motion patterns of the fingerprint area of the user's finger 23 relative to the finger sensor 25. The processor 24 can match the determined finger motion patterns to stored finger motion patterns of respective characters.

For example, the characters are shown to read as “11/3 Hello” on the display 22. The location of the cursor is represented by the underlining of the letter “o”. The letter “o” is represented by two finger motion patterns 26. The first is the finger motion pattern “)” and the second is the finger motion pattern “\hat{ }”. In other words, when the combination of finger motion patterns 26 is entered into the electronic device 20, the respective character 29 that the finger motion patterns represent is displayed on the display 22.

The display 22 is illustratively carried by the housing 21 and connected to the processor 24. In other embodiments, the display 22 can be part of a remote device such as a computer, television or the like that is hardwired connected or wirelessly connected to the electronic device 20 as will be appreciated by those skilled in the art.

The finger sensor 25 may comprise a fingerprint image sensor for generating fingerprint image data. The finger sensor 25 may be a slide-type sensor that can read or determine a fingerprint based upon the friction ridges, for example, as the finger slides over the sensing surface. Such a slide sensor is disclosed in U.S. Pat. No. 6,459,804 to Mainguet, for example, the entire contents of which are incorporated herein by reference. The slide-type finger sensor 25 can have a smaller sensing area than a typical static fingerprint sensor, and its circuitry is compatible with capturing successive slices of the fingerprint image as the finger moves over the sensing surface.

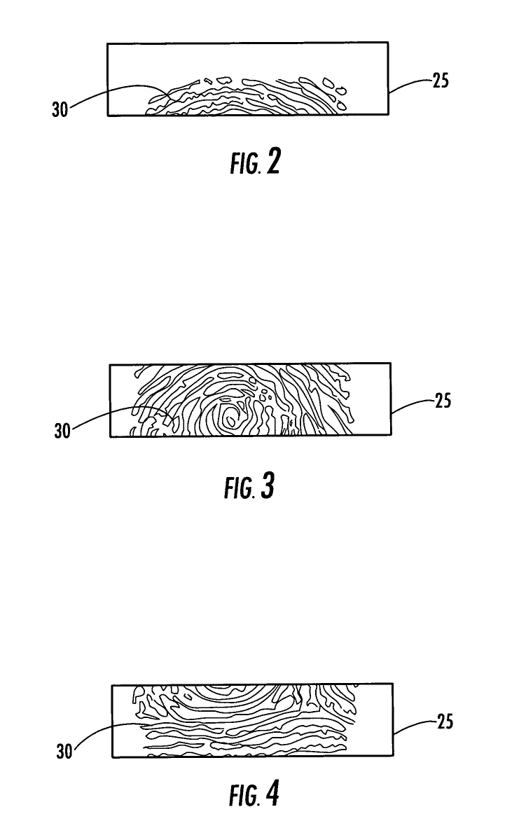

The processor 24 can compare successive slices of fingerprint image data of fingerprint area 30, as shown in FIGS. 2-4, to determine the finger motion patterns as will be appreciated by those skilled in the art. In other embodiments, other finger motion sensing techniques can also be used.

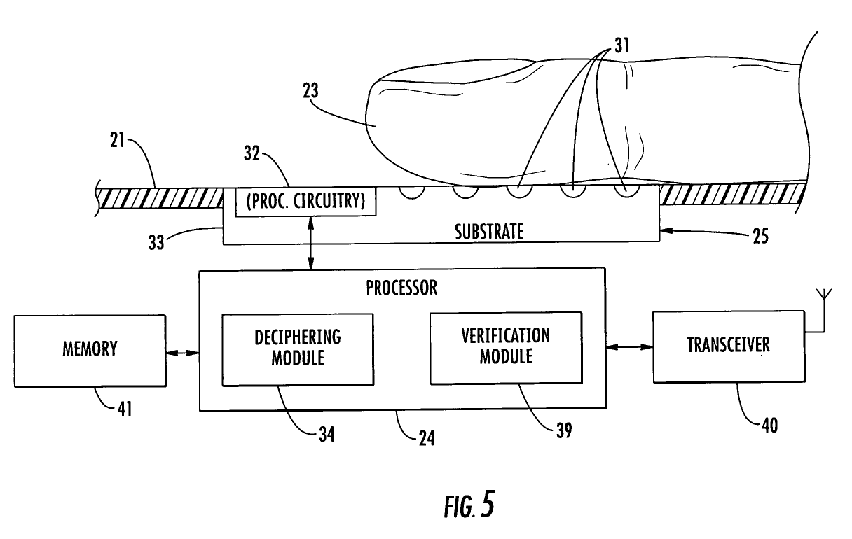

Turning now additionally to FIG. 5, more details of the finger sensor 25 and its construction are now described. The sensor 25 illustratively comprises a substrate 33 and an array of fingerprint sensing pixels 31 on the substrate. The sensor 25 can include processing circuitry 32 for capturing or reading data from the individual sensor pixel elements 31 as will be readily appreciated by those skilled in the art. The sensor 25 is connected to the processor 24, which, in turn, is connected to a memory 41. In other embodiments, the memory 41 may be embedded with the processor.

For example, the array of fingerprint sensing pixels 31 may comprise an array of electric field sensing pixels. The sensor 25 may be similar to the integrated circuit, electric field, fingerprint sensor as disclosed, for example, in U.S. Pat. No. 5,963,679 to Setlak, the entire contents of which are incorporated herein by reference.

The processor 24 further comprises a deciphering module 34 for performing the determining and matching of the finger motion patterns 26. The processor 24 may typically be the onboard processor of the electronic device 20, for example, because such an onboard processor will typically have additional capacity to perform the deciphering function as will be appreciated by those skilled in the art. The processor 24 may alternately be a dedicated processor associated with the finger sensor 25. Of course, the processor may be implemented into the processing circuitry 32 of the integrated circuit of the sensor 25.

The deciphering module 34 can compare successive slices of fingerprint image data to thereby determine motion of the user's finger 23 as discussed above. This motion, in turn, can be compared against a stored set, or alphabet, of finger motions to determine a corresponding character. In particular, a set of fundamental or primitive motions can be used, such as, for example, vertical (up/down) or horizontal (left/right) motion, as well as rotational motion (clockwise/counterclockwise). Moreover, at least some of these fundamental motions can mimic writing of the corresponding letter to be more intuitive for the user.

An exemplary alphabet is provided below as follows wherein the primitives are: \hat{ }=up, v=down, <=left, >=right, (=rotate ccw, )=rotate cw, and wherein { } indicate an optional move is enclosed. A character is indicated by a pattern of one or more primitive moves. A finger motion pattern of moves is performed by placing the finger 23 down, executing the pattern of moves and then raising the finger after completion of the last move in the pattern. Optional moves are used to make certain patterns of several motions easier to perform. For example, the combination of two left moves in a pattern [<<] can be difficult to articulate. Allowing an optional right move between these [<{>}<] makes the pattern much easier for some people to perform. Other primitive moves could be included such as: /=diagonal down and to the left, or \=diagonal down and to the right. Additional primitive moves allow a wider variety of short patterns to be constructed, as will be appreciated by those skilled in the art.

| | |
|---|---|
| standard characters and | |
| numbers | |
| a | < |
| | ( |
| b | v |
| | ) |
| c | ( |
| d | v |
| | ( |
| e | (( or ({)}( |
| f | < |
| | v |
| g | ( |
| | v |
| h | ) |
| | v |
| i | \hat{ } |
| j | v |
| | < |
| k | < |
| | > |
| l | v |
| | > |
| m | > |
| | ( |
| n | > |
| | ) |
| o | ) |
| | \hat{ } |
| p | \hat{ } |
| | ) |
| q | ( |
| | > |
| r | \hat{ } |
| | > |
| s | () |
| t | \hat{ } |
| | < |
| u | > |
| | \hat{ } |
| v | v |
| | \hat{ } |
| w | vv or |
| | v{ }v{ } |
| x | < |
| | \hat{ } |
| y | ( |
| | \hat{ } |
| z | >> or |
| | >{<}> |
| | 0 ) |
| | 1 v |
| | 2 ) |
| | > |
| | 3 )) or |
| | ){(}) |
| | 4 < |
| | ) |
| | 5 ) |
| | < |
| | 6 ( |
| | < |
| | 7 > |
| | v |
| | 8 )( |
| | 9 \hat{ } |
| | ( |
| Standard control | |
| characters | |

| | | |
|---|---|---|
| cap | \hat{ } | capital |
| | v | |
| cr | < | carriage return |
| | > | |
| sp | > | space |
| bsp | < | backspace |
| pct | << or | punctuation mode |
| | <{>}< | |

summary of 3 & 4 move
alternates
m =\hat{ }v\hat{ }v
n =\hat{ }v\hat{ }
e = ({)}(
3 = ){(})
w = v\hat{ }v\hat{ }

In accordance with this example, the total number of patterns of 1 or 2 primitives are 6×6+6=42. The number of alphabetic characters are 26, and the number of numerals are 10 which yields 36 patterns needed. If 4 patterns are reserved as command control prefixes, and 2 reserved for shift and shift lock, the entire pattern set has been allocated. Of course, in other embodiments, other alphabets can be used, and, indeed, a user could program or enter his own specific alphabet as will be appreciated by those skilled in the art.

Accordingly, the characters generated by the electronic device 20 may comprise alphabet characters 35, numeric characters 36, and/or control characters 37 (FIG. 1). Of course, characters are meant to include pictographic characters that form the basis for certain Asian languages as will be appreciated by those skilled in the art. A finger motion pattern can further comprise a finger lifting motion representing transition to a next character, for example.

The processor 24 also illustratively comprises a verification module 39 for determining an authorized user based upon a fingerprint image. The verification module determines, for example, whether a sensed fingerprint matches a stored authorized fingerprint. The matching may be determined by matching fingerprint ridges, minutia, skin pores, etc. as is conventionally used. If the fingerprint matches, such may permit access to further features of the electronic device 20. Of course, the sensor 25 can also be used to enroll a user as an authorized user as will be appreciated by those skilled in the art.

Finger image data from the finger sensor 25 can be used by the deciphering module 34 and the verification module 39 as will be appreciated by those skilled in the art. Accordingly, no additional sensing area or separate device is needed on the relatively limited area of the housing 21 of the electronic device 20.

The electronic device illustratively comprises a wireless transceiver 40, such as for cellphone and/or wireless email message functions as will be appreciated by those skilled in the art. The wireless transceiver 40 is carried by the housing 21 and connected to the processor 24. The wireless transceiver 40 can provide a wireless link 27 to a cellular communications network 28 (FIG. 1).

The electronic device 20 overcomes the disadvantage of a conventional cellular telephone that is desirably so compact that room is not available for a writing surface using a stylus. The electronic device 20 also overcomes the difficulties associated with multiple pressings of a character entry key as needed on many conventional cellphones. In addition, the electronic device 20 may include the finger sensor 25 for security, but could incorporate the character entry feature in accordance with the invention with some additional software. In other words, upgrading an electronic device already including a finger sensor for security to include the character entry is relatively inexpensive and would not typically require any additional hardware or consume additional space on the electronic device as will be appreciated by those skilled in the art.

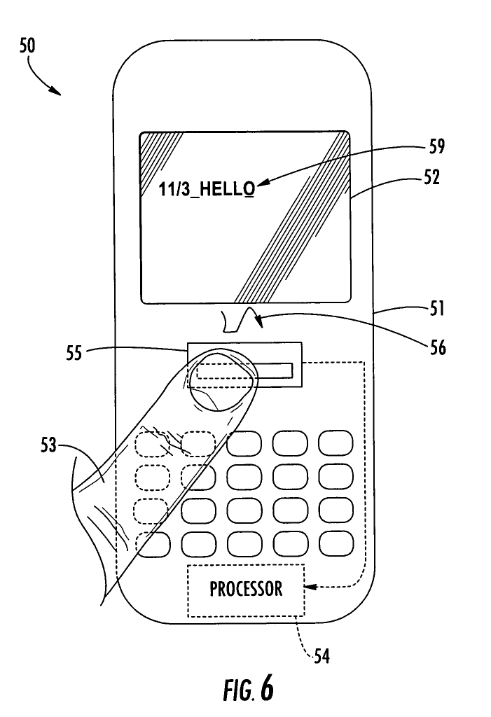

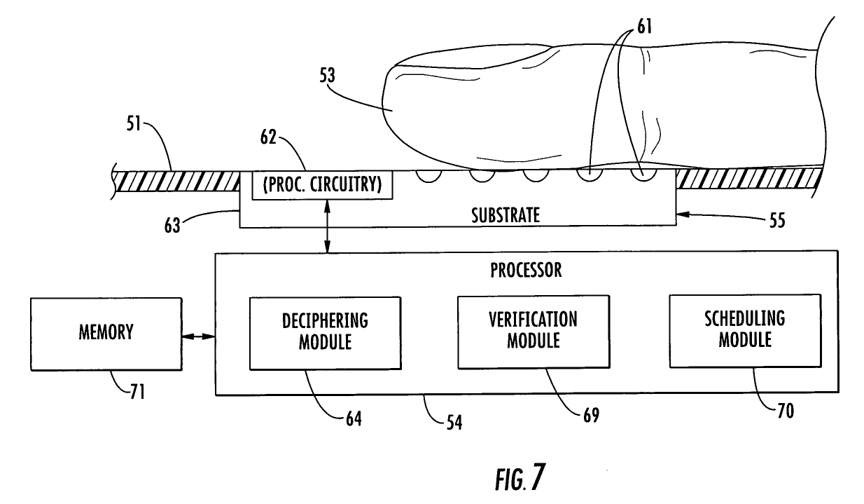

Referring now additionally to FIGS. 6 and 7, an alternate embodiment of an electronic device 50 is now described. In this embodiment, the electronic device 50 is in the form of an electronic organizer, such as a personal digital assistant (“PDA”). The electronic device 50 includes functional circuitry and a rechargeable battery, not shown, carried within the housing 51 to perform typical functions of a PDA, such as scheduling, data storage, data organization, and the like. For example, a scheduling module 70 is illustratively included in the processor 54.

The processor 54 further comprises a deciphering module 64 and verification module 69 that functions in a similar manner as described above. The processor 54 is connected to a memory 71 and the processing circuitry 62 of the sensor 55. The finger sensor 55 illustratively comprises a substrate 63, the processing circuitry 62, and an array of fingerprint sensing pixels 61 on the substrate. A finger 53 can be sensed when adjacent to the array of fingerprint sensing pixels 61 in a similar manner as described above. The electronic device 50 further comprises a display 52 carried by the housing 51 and connected to the processor 54 for displaying the characters 59.

A method aspect of the invention is for using an electronic device that includes a display, and a finger sensor to receive a fingerprint area of a user's finger adjacent thereto. The method may include determining a plurality of finger motion patterns of the fingerprint area of the user's finger relative to the finger sensor, and matching the determined finger motion patterns to stored finger motion patterns for respective characters. The method may further include generating text on said display based upon the characters.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that other modifications and embodiments are intended to be included within the scope of the appended claims.

1. An electronic device comprising:
a housing;
a finger sensor carried by said housing to receive a fingerprint area of a user's finger adjacent thereto;
a display carried by said housing; and
a processor carried by said housing and connected to said finger sensor and said display, said processor for
determining a plurality of finger motion patterns of the fingerprint area of the user's finger relative to said finger sensor,
matching the finger motion patterns to stored finger motion patterns for respective characters, and
generating text on said display based upon the characters.

2. The electronic device according to claim 1 wherein said finger sensor comprises a fingerprint image sensor for generating fingerprint image data.

3. The electronic device according to claim 2 wherein said processor generates and compares successive slices of fingerprint image data to determine the finger motion patterns.

4. The electronic device according to claim 2 wherein said fingerprint image sensor comprises a substrate and an array of fingerprint sensing pixels on said substrate.

5. The electronic device according to claim 4 wherein said array of fingerprint sensing pixels comprises an array of electric field sensing pixels.

6. The electronic device according to claim 1 wherein said processor comprises a deciphering module for performing the determining and matching of the finger motion patterns.

7. The electronic device according to claim 1 wherein the characters comprise at least one of alphabet characters, numeric characters, and control characters.

8. The electronic device according to claim 1 wherein said processor further comprises a verification module for determining an authorized user.

9. The electronic device according to claim 1 wherein at least one finger motion pattern comprises a finger vertical motion.

10. The electronic device according to claim 1 wherein at least one finger motion pattern comprises a finger horizontal motion.

11. The electronic device according to claim 1 wherein at least one finger motion pattern comprises a finger rotational motion.

12. The electronic device according to claim 1 wherein at least one finger motion pattern comprises a finger lifting motion representing transition to a next character.

13. The electronic device according to claim 1 further comprising a wireless transceiver carried by said housing and connected to said processor.

14. The electronic device according to claim 1 wherein said processor further comprises a scheduling module.

15. The electronic device according to claim 1 wherein said housing comprises a portable housing to be carried by the user.

16. An electronic device comprising:
a housing;
a finger image sensor carried by said housing to receive a fingerprint area of a user's finger adjacent thereto, said fingerprint image sensor comprising a substrate and an array of fingerprint sensing pixels on said substrate; and
a processor carried by said housing and connected to said finger image sensor for
determining a plurality of finger motion patterns of the fingerprint area of the user's finger relative to said finger sensor, and
matching the finger motion patterns to stored finger motion patterns for respective characters.

17. The electronic device according to claim 16 wherein said processor generates and compares successive slices of fingerprint image data to determine the finger motion patterns.

18. The electronic device according to claim 16 wherein said processor comprises a deciphering module for performing the determining and matching of the finger motion patterns.

19. The electronic device according to claim 16 wherein the characters comprise at least one of alphabet characters, numeric characters, and control characters.

20. The electronic device according to claim 16 wherein said processor further comprises a verification module for determining an authorized user based upon a fingerprint image.

21. The electronic device according to claim 16 wherein at least one finger motion pattern comprises at least one of a finger vertical motion, a finger horizontal motion, a finger rotational motion, and a finger lifting motion.

22. The electronic device according to claim 16 further comprising a wireless transceiver carried by said housing and connected to said processor.

23. The electronic device according to claim 16 wherein said processor further comprises a scheduling module.

24. The electronic device according to claim 16 wherein said housing comprises a portable housing to be carried by the user.

25. The electronic device according to claim 16 further comprising a display carried by said housing and cooperating with said processor for displaying text based upon the characters.

26. An electronic device comprising:
a housing;
a finger sensor carried by said housing to receive a fingerprint area of a user's finger adjacent thereto; and
a processor carried by said housing and connected to said finger sensor for
determining a plurality of finger motion patterns of the fingerprint area of the user's finger relative to said finger sensor, at least one finger motion pattern comprising a finger rotational motion, and
matching the finger motion patterns to stored finger motion patterns for respective characters.

27. The electronic device according to claim 26 wherein said finger sensor comprises a fingerprint image sensor for generating fingerprint image data.

28. The electronic device according to claim 27 wherein said processor generates and compares successive slices of fingerprint image data to determine the finger motion patterns.

29. The electronic device according to claim 27 wherein said fingerprint image sensor comprises a substrate and an array of fingerprint sensing pixels on said substrate.

30. The electronic device according to claim 26 wherein said processor comprises a deciphering module for performing the determining and matching of the finger motion patterns.

31. The electronic device according to claim 26 wherein the characters comprise at least one of alphabet characters, numeric characters, and control characters.

32. The electronic device according to claim 26 wherein said processor further comprises a verification module for determining an authorized user based upon a fingerprint image.

33. The electronic device according to claim 26 wherein at least one other finger motion pattern comprises at least one of a finger vertical motion, a finger horizontal motion, and a finger lifting motion representing transition to a next character.

34. The electronic device according to claim 26 further comprising a wireless transceiver carried by said housing and connected to said processor.

35. The electronic device according to claim 26 wherein said processor further comprises a scheduling module.

36. The electronic device according to claim 26 wherein said housing comprises a portable housing to be carried by the user.

37. The electronic device according to claim 26 further comprising a display carried by said housing and cooperating with said processor for displaying text based upon the characters.

38. A method of using an electronic device comprising a display, and a finger sensor to receive a fingerprint area of a user's finger adjacent thereto, the method comprising:
determining a plurality of finger motion patterns of the fingerprint area of the user's finger relative to the finger sensor;
matching the determined finger motion patterns to stored finger motion patterns for respective characters; and
generating text on the display based upon the characters.

39. The method according to claim 38 wherein the finger sensor comprises a fingerprint image sensor for generating fingerprint image data.

40. The method according to claim 39 further comprising generating and comparing successive slices of the fingerprint image data to determine the finger motion patterns.

41. The method according to claim 38 wherein the characters comprise at least one of alphabet characters, numeric characters, and control characters.

42. The method according to claim 39 further comprising determining an authorized user based upon the fingerprint image data.

43. The method according to claim 38 wherein the finger motion pattern comprises at least one of a finger vertical motion, a finger horizontal motion, a finger rotational motion, and a finger lifting motion.
